(19) United States
(12) Patent Application Publication
(10) Pub. No.: US 2011/0194098 A1
(43) Pub. Date: Aug. 11, 2011

(54) BEAM IRRADIATION DEVICE

(75) Inventor: Yoichiro Goto, Gifu-City (JP)

(73) Assignee: SANYO Electric Co., Ltd., Moriguchi-shi (JP)

(21) Appl. No.: 13/012,839

(22) Filed: Jan. 25, 2011

(30) Foreign Application Priority Data
Feb. 10, 2010 (JP) 2010-028051
Aug. 31, 2010 (JP) 2010-195155

(51) Int. Cl. G01S 17/08

(52) U.S. Cl. 356/4.01

(57) ABSTRACT

A beam irradiation device includes a laser light source which emits laser light; an actuator which causes the laser light to scan a targeted area; and a wiring portion which supplies a drive signal to the actuator. The actuator includes a first movable portion which is pivotally movable around a first axis, an optical element which is disposed on the first movable portion, and on which the laser light is entered, and a first coil which is disposed on the first movable portion. The wiring portion includes a wiring member which is electrically connected to the first coil, and has a spring property in a flexing direction. The wiring member is disposed at such a position as to urge the first movable portion toward a first scan start position around the first axis, using the spring property.

This application claims priority under 35 U.S.C. Section 119 of Japanese Patent Application No. 2010-28051 filed Feb. 10, 2010, entitled “BEAM IRRADIATION DEVICE” and Japanese Patent Application No. 2010-195155 filed Aug. 31, 2010, entitled “BEAM IRRADIATION DEVICE”. The disclosures of the above applications are incorporated herein by reference.

### BACKGROUND OF THE INVENTION

1. Field of the Invention

The present invention relates to a beam irradiation device for irradiating a targeted area with laser light, and more particularly to a beam irradiation device to be loaded in a so-called laser radar system for detecting a condition of a targeted area based on reflected light of laser light with respect to the targeted area.

2. Disclosure of Related Art

In recent years, a laser radar system has been loaded in a family automobile or a like vehicle to enhance security in driving. Generally, the laser radar system is so configured as to scan a targeted area with laser light to detect presence or absence of an obstacle at each of scanning positions, based on presence or absence of reflected light at each of the scanning positions. The laser radar system is also configured to detect a distance to the obstacle, based on a required time from an irradiation timing of laser light to a light receiving timing of reflected light at each of the scanning positions.

As an arrangement for scanning a targeted area with laser light, there is used an arrangement of driving a mirror about two axes. In the scan mechanism, laser light is entered into the mirror obliquely with respect to a horizontal direction. By driving the mirror about two axes in a horizontal direction and a vertical direction, a targeted area is scanned with laser light. In driving the mirror, an electromagnetic force generated by coils and magnets is used. Coils are mounted on a movable portion for holding a mirror, and magnets are disposed on the side of a base member.

At the time of scanning laser light in a horizontal direction, the mirror is mainly pivotally moved about an axis in parallel to a vertical direction. In performing the scanning operation, the mirror is also slightly pivotally moved about an axis in parallel to a horizontal direction to horizontally scan laser light. When horizontal scanning for one line is completed, the mirror is returned to a position (scan start position) corresponding to the vicinity of a lead end of a succeeding line. Thereafter, the mirror is pivotally moved in a horizontal direction to scan the succeeding line.

In the beam irradiation device having the above arrangement, it is necessary to return the mirror to the scan start position of a succeeding line as soon as possible after the one-line horizontal scanning is completed. As an arrangement for quickly returning the mirror to the scan start position, there is proposed a method of increasing a current to be applied to a coil, or increasing the number of windings of a coil. However, increasing the number of windings of a coil results in an increase in the weight of the movable portion by the increased number of windings, which may lower the drive response of the movable portion. Further, there is a case that an applied current cannot be sufficiently increased depending on the specifications of a coil.

### SUMMARY OF THE INVENTION

A beam irradiation device according to a main aspect of the invention includes a laser light which emits laser light; an actuator which causes the laser light to scan a targeted area; and a wiring portion which supplies a drive signal to the actuator. The actuator includes a first movable portion which is pivotally movable around a first axis, an optical element which is disposed on the first movable portion, and on which the laser light is entered, and a first coil which is disposed on the first movable portion. The wiring portion includes a wiring member which is electrically connected to the first coil, and has a spring property in a flexing direction. The wiring member is disposed at such a position as to urge the first movable portion toward a first scan start position around the first axis, using the spring property.

### BRIEF DESCRIPTION OF THE DRAWINGS

These and other objects, and novel features of the present invention will become more apparent upon reading the following detailed description of the embodiments along with the accompanying drawings.

FIGS. 1A and 1B are diagrams showing an arrangement of a mirror actuator in a first embodiment of the invention.

FIG. 2 is a diagram showing an optical system of a beam irradiation device in the first embodiment.

FIGS. 3A and 3B are diagrams showing the optical system of the beam irradiation device in the first embodiment.

FIGS. 4A through 4D are diagrams showing an arrangement of a first FPC and a mounting method in the first embodiment.

FIGS. 5A and 5B are diagrams showing an arrangement of a second FPC and a mounting method in the first embodiment.

FIGS. 6A through 6C are diagrams for describing an operation of the first FPC in the first embodiment.

FIGS. 7A through 7D are diagrams showing arrangements of the first FPC and the second FPC, and a mounting method as a modification of the first embodiment.

FIGS. 8A through 8C are diagrams showing an arrangement of the first FPC and a mounting method as another modification of the first embodiment.

FIG. 9 is a diagram showing an arrangement of a mirror actuator in a second embodiment of the invention.

FIGS. 10A and 10B are diagrams showing a process of assembling the mirror actuator in the second embodiment.

FIGS. 11A and 11B are diagrams showing a process of assembling the mirror actuator in the second embodiment.

FIGS. 12A through 12D are diagrams for describing arrangements of a first FPC and a second FPC in the second embodiment.

FIGS. 13A through 13D are diagrams for describing a method for mounting the first FPC and the second FPC in the second embodiment.

FIGS. 14A and 14B are diagrams for describing a method for mounting a tilt coil in the second embodiment.

The drawings are provided mainly for describing the present invention, and do not limit the scope of the present invention.

### DESCRIPTION OF PREFERRED EMBODIMENTS

In the following, embodiments of the invention are described referring to the drawings. In the following description, first FPCs 10 and 30 correspond to a wiring member in the claims; second FPCs 20 and 40 correspond to another wiring member in the claims; mirror actuators 100 and 600 correspond to an actuator in the claims; a mirror holder 110 or a pan frame 621 corresponds to a first movable portion in the claims; mirrors 113 and 650 correspond to an optical element in the claims; a coil 114 or a pan coil 623 corresponds to a first coil in the claims; a movable frame 120 or a tilt frame 612 corresponds to a second movable portion in the clams; a coil 126 or tilt coils 613 correspond to a second coil in the claims; and a laser light source 401 corresponds to a laser light source in the claims. The above elements, however, do not limit the scope of the claims.

### First Embodiment

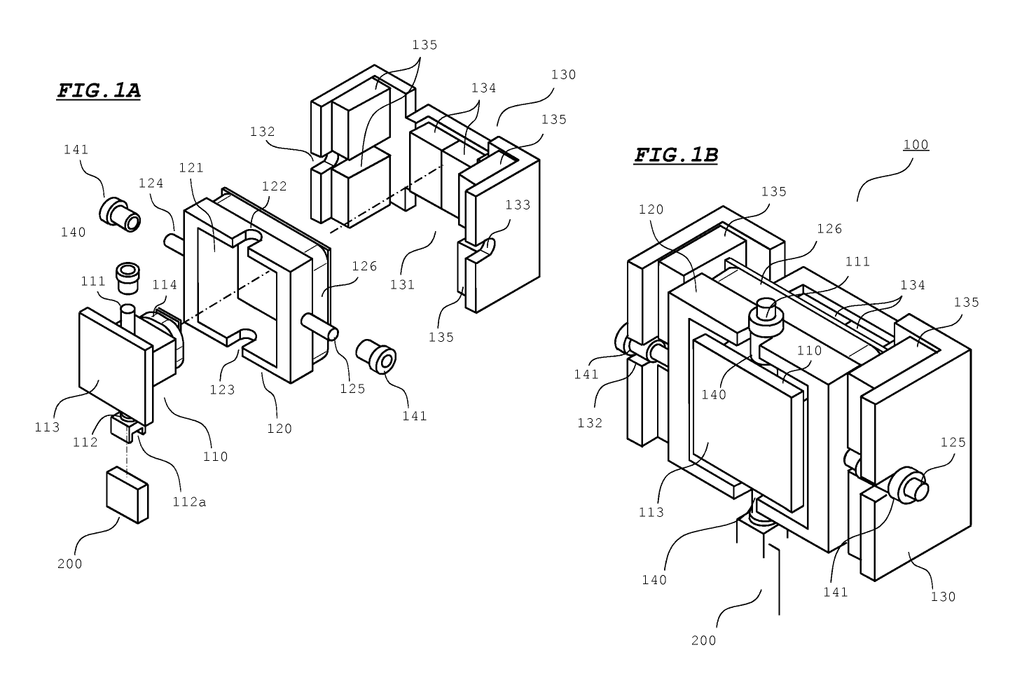

FIGS. 1A and 1B are diagrams showing an arrangement of a mirror actuator 100 in an embodiment of the invention. FIG. 1A is an exploded perspective view of the mirror actuator 100, and FIG. 1B is a perspective view of the mirror actuator 100 in an assembled state.

Referring to FIG. 1A, the reference numeral 110 denotes a mirror holder. The mirror holder 110 is provided with an upper support shaft 111 and a lower support shaft 112. The lower support shaft 112 is formed with a receiving portion 112a. The receiving portion 112a is formed with a recess portion having substantially the same size as the thickness of a transparent member 200. An upper portion of the parallel flat plate-shaped transparent member 200 is mounted in the recess portion. Further, a flat plate-shaped mirror 113 is mounted on a front surface of the mirror holder 110, and a coil 114 is mounted on a back surface of the mirror holder 110. The coil 114 is wound into a rectangular shape.

The transparent member 200 is mounted on the support shaft 112 in such a manner that two flat surfaces of the transparent member 200 are aligned in parallel to a mirror surface of a mirror 113. Further, bearings 140 are mounted on the support shafts 111 and 112.

The reference numeral 120 denotes a movable frame for supporting the mirror holder 110 to be pivotally movable about axes of the support shafts 111 and 112. The movable frame 120 is formed with an opening 121 for housing the mirror holder 110 therein. The movable frame 120 is also formed with grooves 122 and 123 to be engaged with the bearings 140 mounted on the support shafts 111 and 112 of the mirror holder 110. Further, support shafts 124 and 125 are formed on side surfaces of the movable frame 120, and a coil 126 is mounted on a back surface of the movable frame 120. Bearings 141 are mounted on the support shafts 124 and 125. A coil 126 is wound into a rectangular shape.

The reference numeral 130 denotes a fixed frame for supporting the movable frame 120 to be pivotally movable about axes of the support shafts 124 and 125. The fixed frame 130 is formed with a recess portion 131 for housing the movable frame 120 therein. The fixed frame 130 is also formed with grooves 132 and 133 to be engaged with the bearings mounted on the support shafts 124 and 125 of the movable frame 120. Further, magnets 134 for applying a magnetic field to the coil 114, and magnets 135 for applying a magnetic field to the coil 126 are mounted on inner surfaces of the fixed frame 130. The grooves 132 and 133 respectively extend from a front surface of the fixed frame 130 to a gap between the upper and lower two magnets 135.

In assembling the mirror actuator 100, the bearings 140 are mounted on the support shafts 111 and 112 of the mirror holder 110, and then, are mounted in the grooves 122 and 123 of the movable frame 120. With this operation, the mirror holder 110 is supported by the movable frame 120 to be pivotally movable around the support shafts 111 and 112.

In this way, after the mirror holder 110 is mounted on the movable frame 120, the bearings 141 are mounted on the support shafts 124 and 125 of the movable frame 120, and then are mounted in the grooves 132 and 133 of the fixed frame 130. With this operation, the movable frame 120 is mounted on the fixed frame 130 to be pivotally movable around the support shafts 124 and 125. Thus, assembling the mirror actuator 100 is completed.

When the mirror holder 110 is pivotally moved relative to the movable frame 120 about the axes of the support shafts 111 and 112, the mirror 113 is also pivotally moved with the mirror holder 110. Further, when the movable frame 120 is pivotally moved relative to the fixed frame 130 about the axes of the support shafts 124 and 125, the mirror holder 110 is also pivotally moved with the movable flame 120. Thus, the mirror 113 is pivotally moved integrally with the mirror holder 110. In this way, the mirror holder 110 is supported by the support shafts 111 and 112 and the support shafts 124 and 125 perpendicular to each other to be pivotally movable. Further, as the mirror holder 110 is pivotally moved, the mirror 113 is pivotally moved. As the mirror 113 is pivotally moved, the transparent member 200 mounted on the support shaft 112 is also pivotally moved with the mirror 113.

In the assembled state shown in FIG. 1B, the positions and the polarities of the two magnets 134 are adjusted in such a manner that a force for pivotally rotating the mirror holder 110 about the axes of the support shafts 111 and 112 is generated by application of a current to the coil 114. Accordingly, in response to application of a current to the coil 114, the mirror holder 110 is pivotally rotated about the axes of the support shafts 111 and 112 by the electromagnetic driving force generated in the coil 114.

Further, in the assembled state shown in FIG. 1B, the positions and the polarities of the two magnets 135 are adjusted in such a manner that a force for pivotally rotating the movable frame 120 about the axes of the support shafts 124 and 125 is generated by application of a current to the coil 126. Accordingly, in response to application of a current to the coil 126, the movable frame 120 is pivotally rotated about the axes of the support shafts 124 and 125 by the electromagnetic driving force generated in the coil 126, and the transparent member 200 is pivotally rotated in accordance with the pivotal rotation of the movable frame 120.

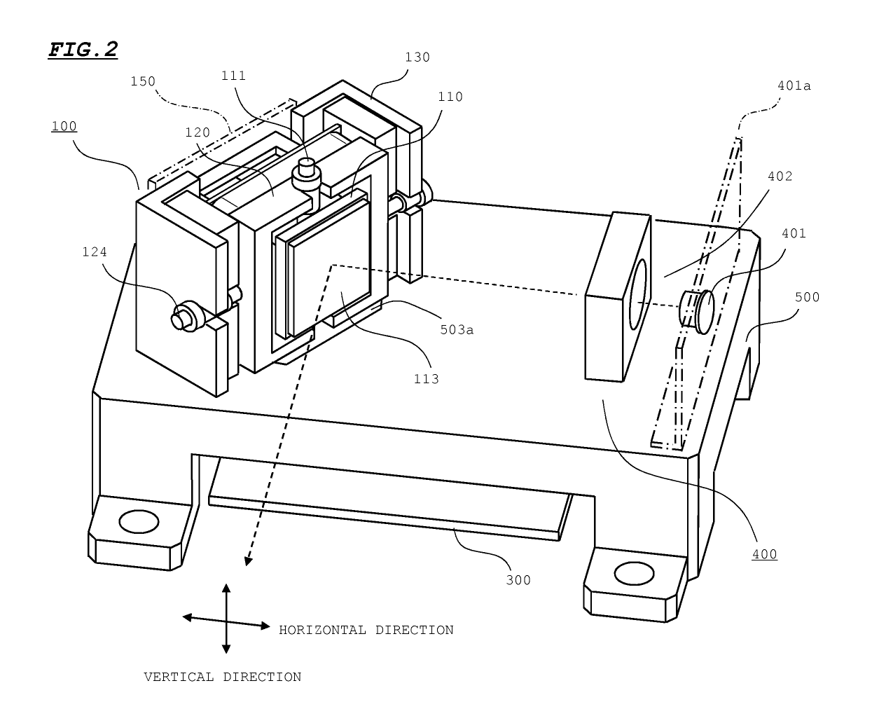

FIG. 2 is a diagram showing an arrangement of an optical system in a state that the mirror actuator 100 is mounted.

Referring to FIG. 2, the reference numeral 500 indicates a base plate for supporting an optical system. The base plate 500 is formed with an opening 503a at a position where the mirror actuator 100 is installed. The mirror actuator 100 is mounted on the base plate 500 in such a manner that the transparent member 200 is received in the opening 503a.

An optical system 400 for guiding laser light to the mirror 113 is mounted on a top surface of the base plate 500. The optical system 400 includes a laser light source 401 (hereinafter, called as “scanning laser light”), and lens 402 for beam shaping. The laser light source 401 is mounted on a substrate 401a for a laser light source, and the substrate 401a is provided on the top surface of the base plate 500.

Laser light emitted from the laser light source 401 is subjected to convergence in a horizontal direction and a vertical direction by the lens 402. The lens 402 is designed in such a manner that the beam shape in a targeted area (e.g. an area defined at a position 100 m away in a forward direction from a beam exit port of a beam irradiation device) has predetermined dimensions (e.g. dimensions of about 2 m in the vertical direction and 1 m in the horizontal direction).

Scanning laser light transmitted through the lens 402 is entered into the mirror 113 of the mirror actuator 100, and is reflected toward the targeted area by the mirror 113. When the mirror 113 is driven by the mirror actuator 100, the targeted area is scanned by scanning laser light.

The mirror actuator 100 is disposed at such a position that scanning laser light from the lens 402 is entered into the mirror surface of the mirror 113 at an incident angle of 45 degrees with respect to the horizontal direction, when the mirror 113 is set to a neutral position. The term “neutral position” indicates a position of the mirror 113, wherein the mirror surface is aligned in parallel to the vertical direction, and scanning laser light is entered into the mirror surface at an incident angle of 45 degrees with respect to the horizontal direction.

A circuit board 150 for supplying a drive signal to the coils 114 and 126 of the mirror actuator 100 is disposed behind the mirror actuator 100, on the top surface of the base block 500, in addition to a circuit board 401a and other members. Further, a circuit board 300 is disposed underneath the base block 500, and circuit boards 301 and 302 are disposed on a side surface and a back surface of the base block 500.

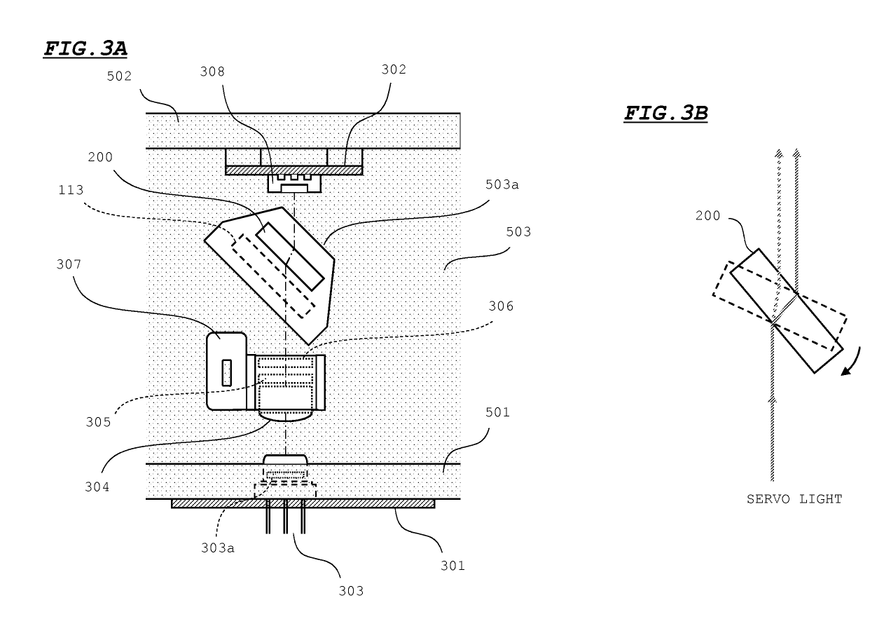

FIG. 3A is a partial plan view of the base plate 500, viewed from the back side of the base plate 500. FIG. 3A shows a part of the back surface of the base plate 500, i.e. a vicinity of the position where the mirror actuator 100 is mounted.

As shown in FIG. 3A, walls 501 and 502 are formed on the periphery of the back surface of the base plate 500. A flat surface 503 lower than the walls 501 and 502 is formed in a middle portion of the back surface of the base plate 500 with respect to the walls 501 and 502. The wall 501 is formed with an opening for receiving a semiconductor laser 303. The circuit board 301 loaded with the semiconductor laser 303 is attached to an outer side surface of the wall 501 in such a manner that the semiconductor laser 303 is received in the opening of the wall 501. Further, the circuit board 302 loaded with a PSD 308 is attached to a position near the wall 502.

A light collecting lens 304, an aperture 305, and a ND (neutral density) filter 306 are mounted on the flat surface 503 on the back surface of the base plate 500 by an attachment member 307. The flat surface 503 is formed with an opening 503a, and the transparent member 200 mounted on the mirror actuator 100 is projected from the back surface of the base plate 500 through the opening 503a. In this example, when the mirror 113 of the mirror actuator 100 is set to the neutral position, the transparent member 200 is set to such a position that the two flat surfaces of the transparent member 200 are aligned in parallel to the vertical direction, and are inclined with respect to an optical axis of emission light from the semiconductor laser 303 by 45 degrees.

Laser light (hereinafter, called as “servo light”) emitted from the semiconductor laser 303 transmitted through the light collecting lens 304 has the beam diameter thereof reduced by the aperture 305, and has the light intensity thereof reduced by the ND filter 306. Thereafter, the servo light is entered into the transparent member 200, and subjected to refraction by the transparent member 200. Thereafter, the servo light transmitted through the transparent member 200 is received by the PSD 308, which, in turn, outputs a position detection signal depending on a light receiving position of servo light.

FIG. 3B is a diagram schematically showing how the pivotal position of the transparent member 200 is detected by the PSD 308.

Servo light is refracted by the transparent member 200 disposed with an inclination with respect to an optical axis of laser light. In this arrangement, when the transparent member 200 is pivotally moved from the broken-line position in the arrow direction, the optical path of servo light is changed from the dotted-line position to the solid-line position in FIG. 3B, and the light receiving position of servo light on the PSD 308 is changed. With this operation, the moving position of the transparent member 200 can be detected based on the light receiving position of servo light detected by the PSD 308. Then, the scanning position of scanning laser light in the targeted area can be detected, based on the moving position of the transparent member 200.

In this embodiment, power supply from the circuit board 150 to the coils 114 and 126 is performed by a flexible printed circuit board (FPC). A connector is disposed at one end of the FPC, and the connector is connected to a connector on the side of the circuit board 150. Further, the FPC, and the coils 114 and 126 are connected by soldering. Furthermore, the FPC is adhesively fixed to the back surface of the movable frame 120.

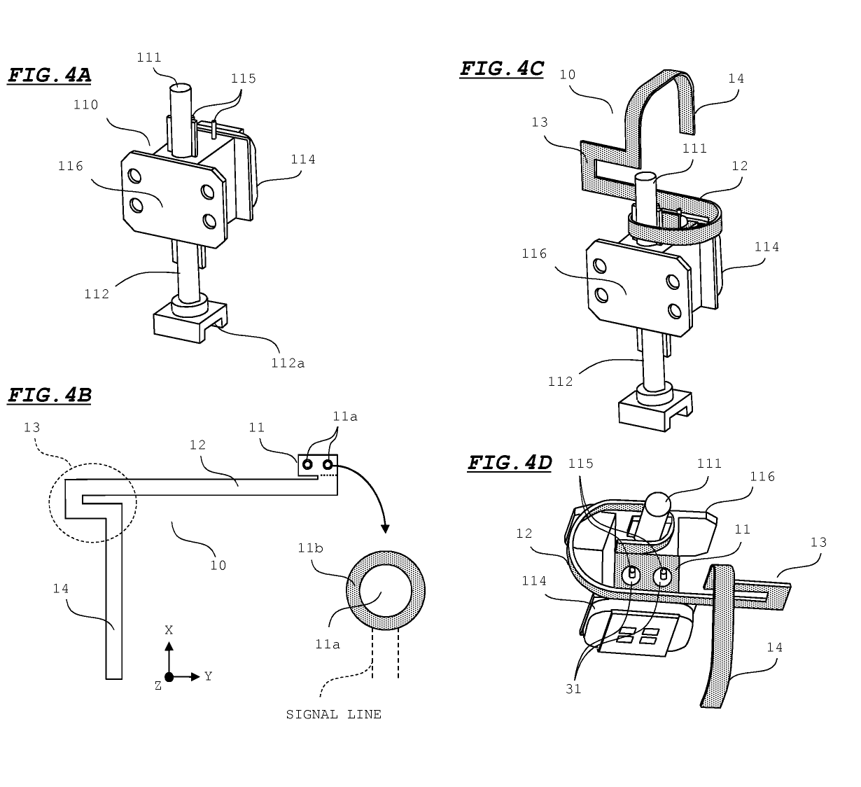

FIGS. 4A through 4D are diagrams for describing an arrangement of a first FPC 10 for supplying power to the coil 114, and a mounting method. FIG. 4A is a perspective view showing details of an arrangement of the mirror holder 110. FIG. 4B is a plan view showing an arrangement of the first FPC 10. FIGS. 4C and 4D are respectively perspective views of a mounted state of the first FPC 10, when a forward right portion of the first FPC 10 is viewed obliquely from above, and a rearward portion of the first FPC 10 is viewed obliquely from above.

Referring to FIG. 4A, two pins 115 project from the upper surface of the mirror holder 110. The reference numeral 116 denotes a mounting surface on which the mirror 113 is mounted.

Referring to FIG. 4B, the first FPC 10 is provided with a mounting portion 11, straight portions 12 and 14, and a bent portion 13. The mounting portion 11 is formed with two holes 11a passing through the mounting portion 11 in Z-axis direction. As shown by the enlarged view indicated by the arrow in FIG. 4B, an electrode 11b is exposed from the upper surface of the mounting portion 11 around each of the holes 11a. The two holes 11a are disposed at the positions corresponding to the two pins 115 provided on the upper surface of the mirror holder 110.

The first FPC 10 has a small thickness in Z-axis direction in FIG. 4B, and is flexible with elasticity in Z-axis direction. A connector (not shown) is disposed at one end of the straight portion 14. Two signal lines extend from the connector to the electrodes 11b of the mounting portion 11 along the upper surface of the first FPC 10. The upper surface and the lower surface of the first FPC 10 are covered by an insulating member. The two holes 11a and portions around the electrodes 11b are not covered by an insulating member.

The first FPC 10 is mounted on the mirror actuator 100 as follows. Firstly, a portion comprised of the straight portions 12 and 14 and the bent portion 13 is bent in Z-axis direction at the dotted-line position in FIG. 4B near the mounting portion 11. In this state, the pins 115 are inserted into the two holes 11a, and the mounting portion 11 is adhesively fixed to the upper surface of the mirror holder 110. Further, both ends of the coil 114 mounted on the back surface of the mirror holder 110 are wound around the corresponding pins 115. In this state, the end portions of the coil 114 are connected to the corresponding electrodes 11b formed around the holes 11a by soldering. Thus, the first FPC 10 is mounted on the mirror holder 110. In performing the above operation, the bent portion (shown by the dotted-line position) of the first FPC 10 may be reinforced by coating an adhesive or a like material to the bent portion to prevent damage/short-circuiting of a base of the bent portion.

Then, after the straight portion 12 is wound around the support shaft 111, the first FPC 10 is adhesively fixed to the back surface of the movable frame 120.

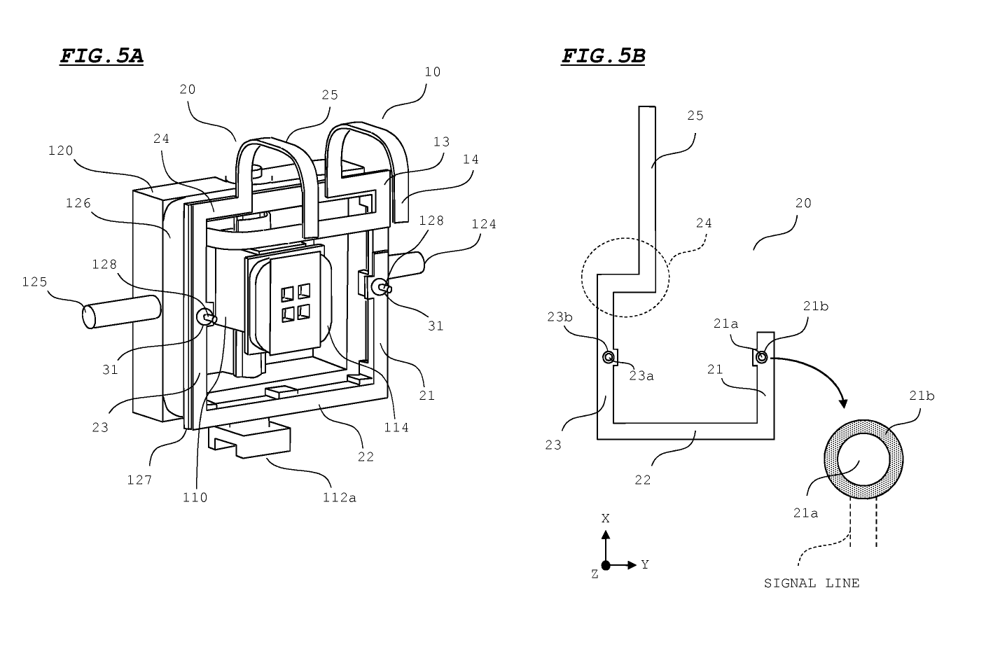

FIG. 5A is a perspective view of the movable frame 120 in a state that the mirror holder 110 is mounted, when viewed from the back surface side of the movable frame 120. A frame-shaped pressing plate 127 for pressing the coil 126 is mounted on the back surface side of the movable frame 120. The bent portion 13 of the first FPC 10 is adhesively fixed to an upper right corner portion of the pressing plate 127. In this state, the straight portion 14 is bent downwardly, and a connector disposed at the end of the straight portion 14 is connected to the connector of the circuit board 150 shown in FIG. 2.

FIGS. 4C and 4D show the first FPC 10 in a state that the first FPC 10 is mounted. In FIGS. 4C and 4D, illustration of the movable frame 120 is omitted to simplify the description. Further, illustration of the coil 114 wound around the pins 115 is also omitted. The reference numeral 31 in FIG. 4D denotes a solder.

FIG. 5B is a plan view showing an arrangement of a second FPC 20 for supplying a current to the coil 126. The second FPC 20 is provided with straight portions 21, 22, 23, and 25; and a bent portion 24. The straight portions 21 and 23 are respectively formed with holes 21a and 23a passing through the straight portions 21 and 23 in Z-axis direction. As shown by the enlarged view indicated by the arrow in FIG. 5B, an electrode 21b is exposed from the upper surface of the straight portion 21 around the hole 21b. Likewise, an electrode 23b is disposed around the hole 23a.

The second FPC 20 has a small thickness in Z-axis direction in FIG. 5B, and is flexible with elasticity in Z-axis direction. A connector (not shown) is disposed at one end of the straight portion 25. Two signal lines extend from the connector to the electrodes 21b and 23b along the upper surface of the second FPC 20. The upper surface and the lower surface of the second FPC 20 are covered by an insulating member. The two holes 21a and 23a and portions around the electrodes 21b and 23b are not covered by an insulating member.

Referring to FIG. 5A, pins 128 project from the pressing plate 127 at the positions corresponding to the two holes 21a and 23a. The pins 128 are inserted into the two holes 21a and 23a, and the straight portions 21, 22, and 23 are adhesively fixed to the back surface of the pressing plate 127. Further, both ends of the coil 126 mounted on the back surface of the movable frame 120 are wound around the corresponding pins 128. In this state, the end portions of the coil 126 and the electrodes 21b and 23b around the holes 21a and 23a are connected by the solder 31. Thus, the second FPC 20 is mounted to the movable frame 120. In this state, the straight portion 25 is bent downwardly, and the connector disposed at the end of the straight portion 25 is connected to the connector of the circuit board 150 shown in FIG. 2.

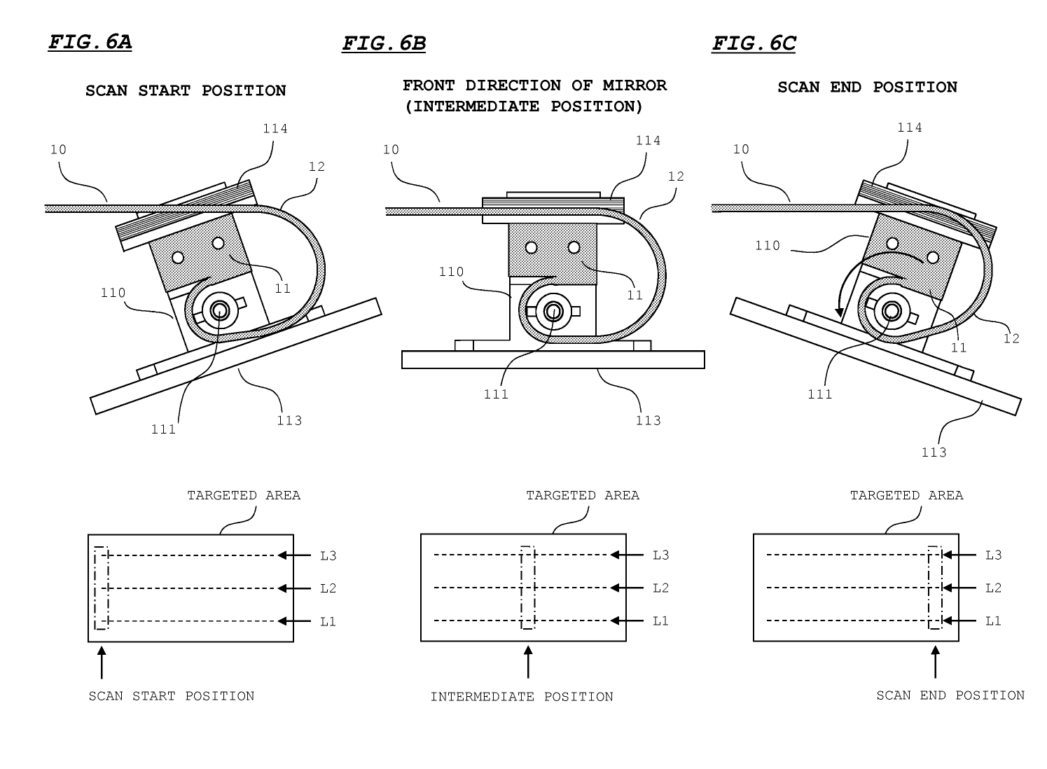

Next, the operation of the first FPC 10 is described referring to FIGS. 6A through 6C.

FIGS. 6A through 6C are respectively schematic views showing states of the mirror holder 110 at a scan start position, an intermediate position, and a scan end position, when viewed from above (in the direction along the support shaft 111). Further, the lower portions in FIGS. 6A through 6C schematically and respectively show relations between scanning lines (L1, L2, L3) in a targeted area, and scanning positions (shown by the one-dotted-chain lines in FIGS. 6A through 6C) of scanning laser light when the mirror holder 110 is set to the scan start position, the intermediate position, and the scan end position.

When scanning laser light scans a targeted area in a horizontal direction, the mirror holder 110 is pivotally moved around the support shafts 111 and 112 from the scan start position shown in FIG. 6A to the scan end position shown in FIG. 6C via the intermediate position shown in FIG. 6B. In performing the above operation, it is necessary to quickly return the mirror holder 110 from the scan end position shown in FIG. 6C to the scan start position shown in FIG. 6A for a succeeding scanning line, upon completion of scanning of a certain scanning line.

Normally, the returning operation is performed by applying a current to the coil 114 in such a direction as to cause the coil 114 to generate a driving force in the returning direction. In quickly performing the returning operation, a large current is required to be applied to the coil 114. However, there is a case that an applied current cannot be sufficiently increased depending on the specifications of a coil. In such a case, it is difficult to raise the returning speed of the mirror holder 110 for a returning operation. There is proposed a method of raising the returning speed by increasing the number of windings of the coil 114 i.e. enhancing the driving force of the coil 114. However, if the number of windings of the coil is increased, the weight of the mirror holder 110 is increased by the increased number of windings, which may lower the drive response of the mirror holder 110.

As described above, however, in this embodiment, the bent portion 13 of the first FPC 10 is adhesively fixed to the movable frame 120 in a state that the straight portion 12 of the first FPC 10 is wound around the support shaft 111. With this arrangement, the mirror holder 110 is urged counterclockwise by a spring property (a resilient recovering force) of the straight portion 12 at the scan end position shown in FIG. 6C. The urging force is continued to be imparted to the mirror holder 110 during a period when the mirror holder 110 is returned from the scan end position shown in FIG. 6C to the scan start position shown in FIG. 6A. Accordingly, in this embodiment, the mirror holder 110 is assisted by the urging force in returning to the scan start position. Thus, it is possible to quickly return the mirror holder 110 to the scan start position, without the need of exceedingly increasing a current to be applied to the coil 114 during the returning operation.

As described above, the embodiment is advantageous in quickly returning the mirror holder 110 by the simplified approach of using an arrangement of the first FPC 10 and a method of improving a mounted state.

In this embodiment, as shown in FIG. 5A, since both of the straight portion 14 of the first FPC 10 and the straight portion 25 of the second FPC 20 are bent downwardly, the movable frame 120 is urged to be tilted downwardly by a spring property (a resilient recovering force) of the straight portions 14 and 25. In view of this, in this embodiment, the scan start position of the movable frame 120 around the support shafts 124 and 125 may be set to such a position that the movable frame 120 is tilted downwardly. Specifically, control may be performed so that a scanning operation is performed from the lowermost scanning line L1 to the uppermost scanning line L3 shown in the lower portions in FIGS. 6A through 6C. With this operation, after the uppermost scanning line L3 is scanned, the movable frame 120 can be quickly returned to the position (scan start position around the support shafts 124 and 125) corresponding to the lowermost scanning line L1 by an assisting operation using a spring property (a resilient recovering force) of the straight portions 14 and 25.

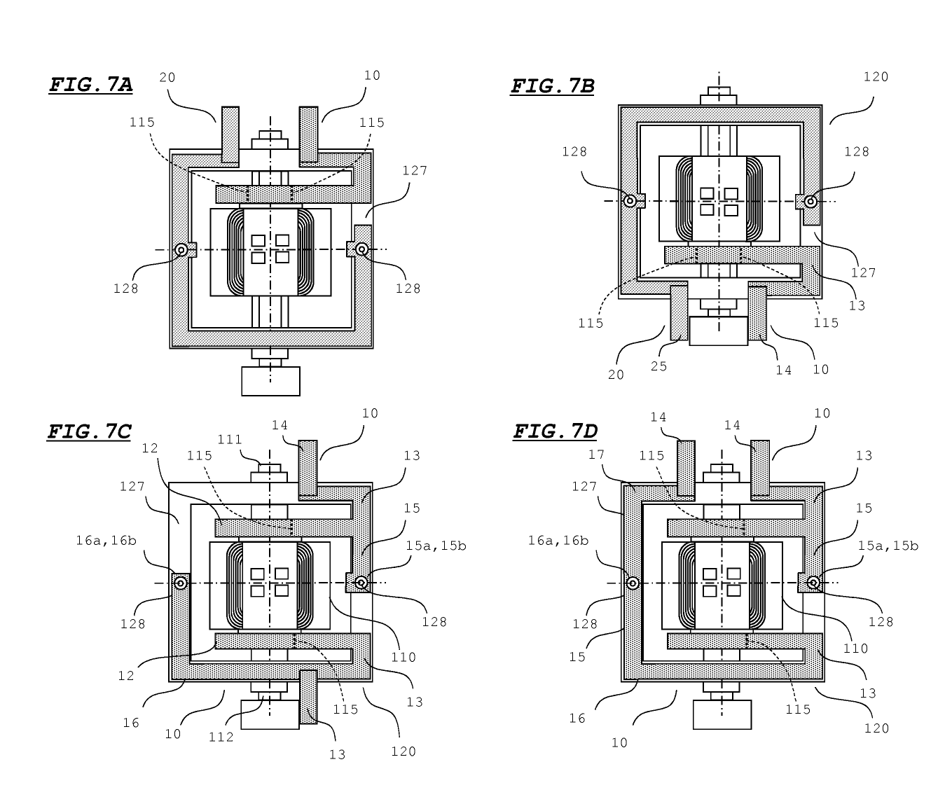

In the case where a scanning operation is successively performed from the uppermost scanning line L3 to the lowermost scanning line L1 shown in the lower portions in FIGS. 6A through 6C, the first FPC 10 and the second FPC 20 may be mounted upside down with respect to the arrangement shown in FIG. 5A. FIG. 7B is a diagram showing an arrangement of the modification, when viewed from the rear side of the movable frame 120. The mounting portion 11 of the first FPC 10 is mounted on the lower surface of the mirror holder 110, and is connected to the coil 114 by soldering. Two pins 115 project from the lower surface of the mirror holder 110, and the pins 115 are inserted into the holes 11a of the mounting portion 11. FIG. 7A shows an arrangement of the embodiment shown in FIGS. 4A through 6C.

When the mirror actuator is configured as shown in FIG. 7B, the movable frame 120 is applied with an upward urging force by a spring property (a resilient recovering force) of the straight portions 14 and 25. This enables to quickly return the movable frame 120 to the scan start position (position corresponding to the scanning line L3 shown in the lower portions in FIGS. 6A through 6C).

The arrangement of the first embodiment may be modified in various ways other than the above.

For instance, as shown in FIG. 7C, a mounting portion 11 of a first FPC 10 may be disposed on both of the upper surface and the lower surface of a mirror holder 110. In the modification, one hole 11a and one electrode 11b are disposed on each of the mounting portions 11, and pins 115 to be inserted into the respective holes 11a project from the upper surface and the lower surface of the mirror holder 110. One end of a coil 114 is wound around the upper-side pin 115, and the other end of the coil 114 is wound around the lower-side pin 115. Then, both ends of the coil 114 are connected to the corresponding electrodes 11b by soldering. Similarly to the embodiment, bent portions 13 of the respective first FPCs 10 are adhesively fixed to a pressing plate 127.

In the arrangement shown in FIG. 7C, the two first FPCs 10 are also used to supply power to a coil 126 mounted on the back surface of a movable frame 120. In view of this, the upper-side first FPC 10 is formed with a straight portion 15 extending from the bent portion 13 to a right-side pin 128. The straight portion 15 is formed with a hole 15a at the position corresponding to the right-side pin 128, and an electrode 15b is disposed around the hole 15a. Further, the lower-side first FPC 10 is formed with an L-shaped portion 16 extending from the bent portion 13 to a left-side pin 128. The L-shaped portion 16 is formed with a hole 16a at the position corresponding to the left-side pin 128, and an electrode 16b is disposed around the hole 16a.

The electrode 15b is connected to a connector at an end of a straight portion 14 of the upper-side first FPC 10, and the electrode 16b is connected to a connector at an end of a straight portion 14 of the lower-side first FPC 10. Similarly to the embodiment, the pins 128 are inserted into the corresponding holes 15a and 16a. One end of the coil 126 is wound around one of the pins 128, and the other end of the coil 126 is wound around the other one of the pins 128. Thus, both ends of the coil 126 are connected to the corresponding electrodes 15b and 16b by soldering.

In the arrangement shown in FIG. 7C, both of straight portions 12 of the two first FPCs 10 extend from the upper surface of the mirror holder 110 to the lower surface of the mirror holder 110, while being wound around the support shafts 111 and 112 from the left side in FIG. 7C. Accordingly, the mirror holder 110 receives urging forces for pivotally moving the mirror holder 110 in the same direction by a spring property (a resilient recovering force) of the two straight portions 12. Thus, in the above arrangement example, an assisting force of about two times of the assisting force in the embodiment is applied to the mirror holder 110 when the mirror holder 110 is returned to the scan start position around the support shafts 111 and 112. This enables to more quickly return the mirror holder 110 to the scan start position, as compared with the embodiment.

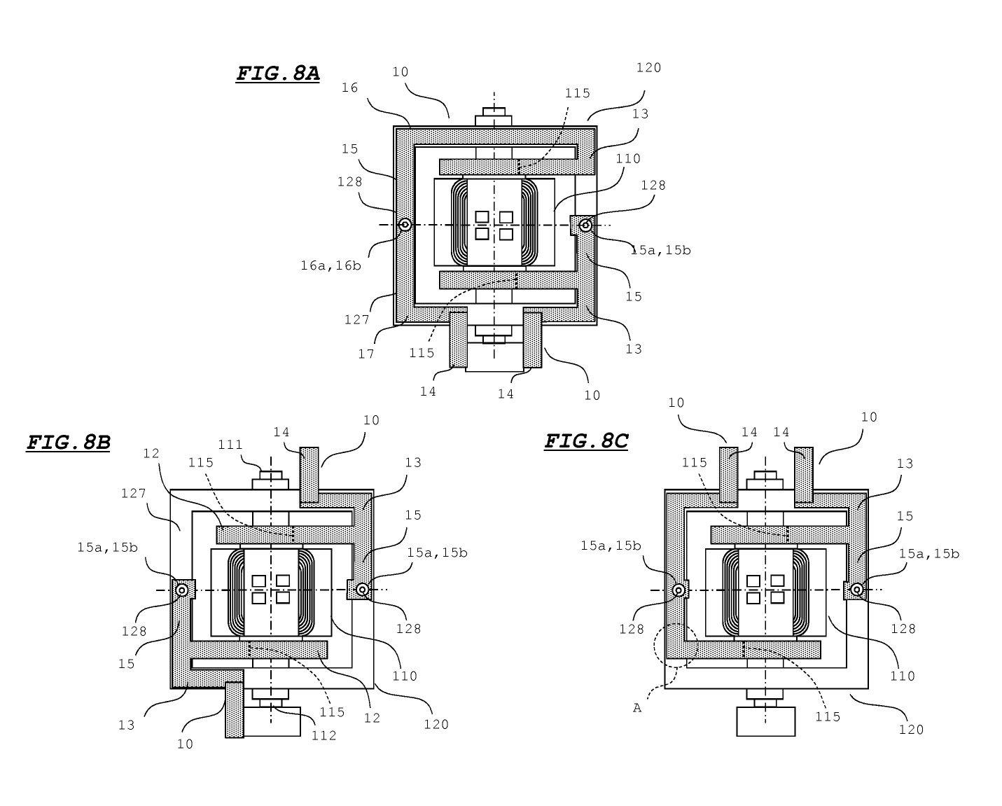

In the arrangement shown in FIG. 7C, since the bending directions of the straight portions 14 of the upper-side first FPC 10 and the lower-side first FPC 10 are opposite to each other, the directions along which the movable frame 120 is urged by the straight portions 14 are also opposite to each other, and the urging forces by the two straight portions 14 are cancelled with each other. Thus, for instance, when the movable frame 120 is urged downwardly, as shown in FIG. 7D, the straight portion 14 of the lower-side first FPC 10 is positioned on the upper side with respect to the movable frame 120, and the straight portion 14 and the L-shaped portion 16 are connected to an L-shaped portion 17. In this case, the L-shaped portion 17 is adhesively fixed to the pressing plate 127. Further, when the movable frame 120 is urged upwardly, as shown in FIG. 8A, the two first FPCs 10 may be mounted upside down with respect to the arrangement shown in FIG. 7D.

Further alternatively, as shown in FIG. 8B, a first FPC 10 having the same configuration as the upper-side first FPC 10 shown in FIG. 7C may be disposed on the lower side. In this modification, a straight portion 12 of the upper-side first FPC 10 extends to the upper surface of a mirror holder 110 while being wound around a support shaft 111 from the left side in FIG. 8B. On the other hand, a straight portion 12 of the lower-side first FPC 10 extends to the lower surface of the mirror holder 110 while being wound around a support shaft 112 from the right side in FIG. 8B. With this arrangement, the mirror holder 110 receives urging forces for pivotally moving the mirror holder 110 in opposite directions to each other by a spring property (a resilient recovering force) of the two straight portions 12. Thus, in the above arrangement example, urging forces by the two straight portions 14 are cancelled with each other.

In the above arrangement, the spring property (a resilient recovering force) by the straight portion 12 of the upper-side first FPC 10 is also larger than the spring property (a resilient recovering force) by the straight portion 12 of the lower-side first FPC 10 at the scan end position shown in FIG. 6C. Accordingly, the mirror holder 110 receives an urging force directed toward the scan start position by the straight portion 12 of the upper-side first FPC 10. Thus, in the above arrangement, the mirror holder 110 is assisted by the straight portion 12 at the time of returning the mirror holder 110, which requires a particularly large driving force. The above arrangement enables to quickly return the mirror holder 110 to the scan start position.

In the case where the mirror holder 110 is controlled so that the scan start position around the support shafts 111 and 112 coincides with the intermediate position shown in FIG. 6B, it is possible to quickly return the mirror holder 110 to the scan start position (intermediate position), because the mirror holder 110 receives an urging force by the straight portions 12, irrespective of in which direction (rightward or leftward direction) the mirror holder 110 is swung from the intermediate position shown in FIG. 8B.

In the arrangement shown in FIG. 8B, similarly to the arrangement shown in FIG. 7C, since the bending directions of the upper and lower two straight portions 14 are opposite to each other, urging forces by the two straight portions 14 are cancelled with each other. Accordingly, for instance, in the case where the mirror holder 110 is urged downwardly, the arrangement of the lower-side first FPC 10 may be modified as shown in FIG. 8C. Likewise, in the case where the mirror holder 110 is urged upwardly, two first FPCs 10 may be mounted upside down with respect to the arrangement shown in FIG. 8C.

### Second Embodiment

In the following, an embodiment in the case where the arrangement of the mirror actuator is modified is described.

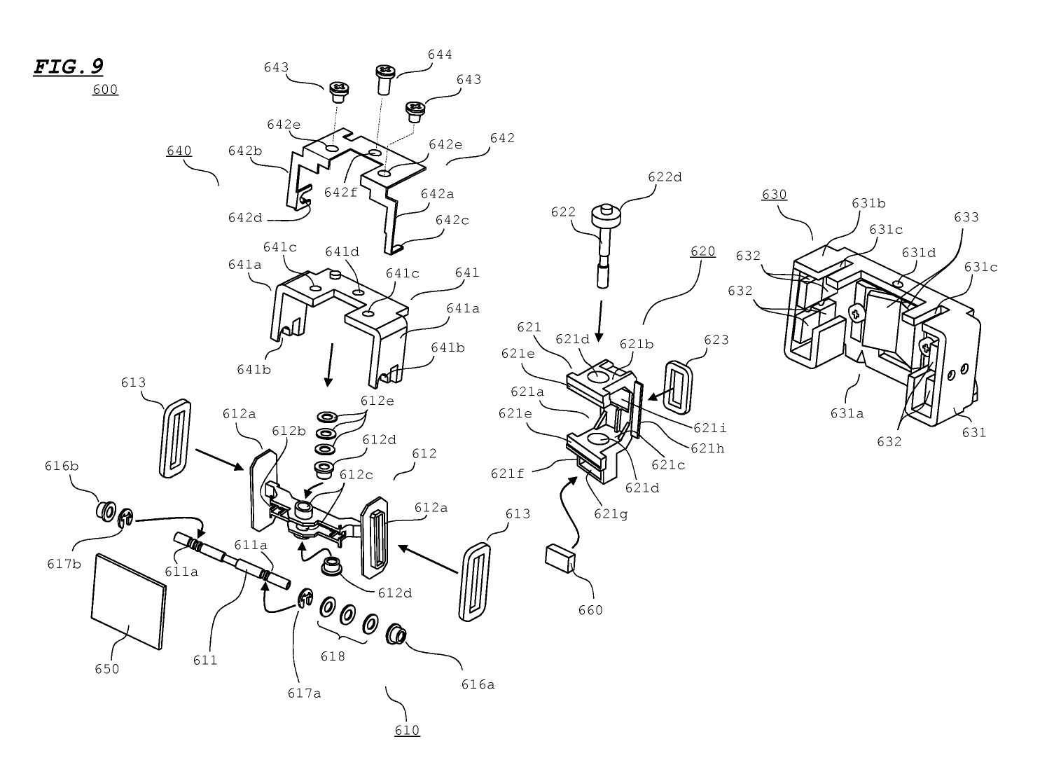

FIG. 9 is an exploded perspective view showing an arrangement of a mirror actuator 600 in the second embodiment of the invention.

The mirror actuator 600 is provided with a tilt unit 610, a pan unit 620, a magnet unit 630, a yoke unit 640, a mirror 650, and a transparent member 660.

The tilt unit 610 is provided with a support shaft 611, a tilt frame 612, and two tilt coils 613. The support shaft 611 is formed with grooves 611a near both ends of the support shaft 611. E-rings 617a and 617b are mounted in the respective grooves 611a.

The tilt frame 612 is formed with coil mounting portions 612a at left and right ends thereof for mounting the tilt coils 613. The tilt frame 612 is further formed with a groove 612b for engaging the support shaft 611, and vertically aligned two holes 612c.

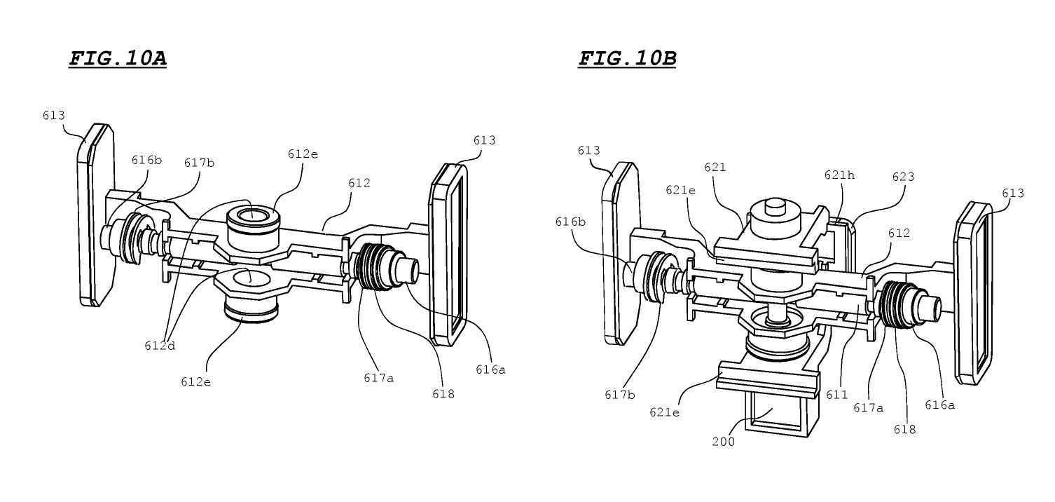

The support shaft 611 is engaged in the groove 612b formed in the tilt frame 612, and adhesively fixed to the tilt frame 612 in a state that bearings 616a and 616b, the E-rings 617a and 617b, and polyslider washers 618 are mounted on both side of the support shaft 611. Further, bearings 612d are mounted in the two holes 612c in the tilt frame 612 from an upper direction and a lower direction. With this operation, as shown in FIG. 10A, assembling of the tilt unit 610 is completed. FIG. 10A shows a state that the bearings 616a and 616b, the E-rings 617a and 617b, and the three polyslider washers 618 are mounted on the support shaft 611.

The pan unit 620 is mounted on the assembled tilt unit 610 in the manner as described below. Thereafter, the tilt unit 610 is attached to a yoke 641 in the manner as described below, using the bearings 616a and 616b, the E-rings 617a and 617b, the polyslider washers 618, and a shaft fixing member 642.

Referring back to FIG. 9, the pan unit 620 is provided with a pan frame 621, a support shaft 622, and a pan coil 623. The pan frame 621 is formed with an upper plate portion 621b and a lower plate portion 621c, with a recess portion 621a being formed therebetween. The upper plate portion 621b and the lower plate portion 621c are formed with vertically aligned through-holes 621d for passing the support shaft 622. Further, a step portion 621e is formed on a front surface of each of the upper plate portion 621b and the lower plate portion 621c for placing a mirror 650.

Further, a downwardly extending leg portion 621f is formed on the lower plate portion 621c, and an opening 621g is formed through the leg portion 621f to extend in forward and rearward directions. The transparent member 660 is mounted in the opening 621g in forward and rearward directions. A coil mounting portion 621h for mounting the pan coil 623 is formed on the back surface of the pan frame 621. Further, an opening 621i communicating with the recess portion 621a is formed in the back surface of the pan frame 621. A balancer 622d is attached to an upper end of the support shaft 622.

The magnet unit 630 is provided with a frame 631, two pan magnets 633, and eight tilt magnets 632. The frame 631 has such a shape that a recess portion 631a is formed on the front side thereof. An upper plate portion 631b of the frame 631 is formed with horizontally extending two cutaways 631c, and is further formed with a screw hole 631d in the middle thereof. The eight tilt magnets 632 are mounted in upper and lower two rows on the left and right inner surfaces of the frame 631. Further, as shown in FIG. 9, the two pan magnets 633 are mounted on the rear inner surface of the frame 631 with a certain inward inclination.

Slits (not shown) for passing a first FPC 710 and a second FPC 720 to be described later from the interior of the frame 631 to the back surface side thereof are formed in an upper portion on the back surface of the frame 631.

The yoke unit 640 is provided with the yoke 641 and the shaft fixing member 642. The yoke 641 is constituted of a magnetic member. The yoke 641 is formed with wall portions 641a at left and right sides thereof, and recess portions 641b for mounting the support shaft 611 of the tilt unit 610 are formed in respective lower ends of the wall portions 641a. The yoke 641 is formed with vertically extending two screw through-holes 641c in an upper portion thereof, and is further formed with a screw hole 641d at a position corresponding to the screw hole 631d of the magnet unit 630. The distance between the inner side surfaces of the two wall portions 641a is set larger than the distance between the two grooves 611d of the support shaft 611.

The shaft fixing member 642 is a thin plate metal member having flexibility. Plate spring portions 642a and 642b are formed on a front portion of the shaft fixing member 642. Receiving portions 642c and 642d for restricting falling of the bearings 616a and 616b of the tilt unit 110 are formed on respective lower ends of the plate spring portions 642a and 642b. Further, an upper plate portion of the shaft fixing member 642 is formed with holes 642e at positions corresponding to the two screw holes 641c of the yoke 641, and is further formed with a hole 642f at a position corresponding to the screw hole 641d of the yoke 641.

In assembling the mirror actuator 600, the tilt unit 610 shown in FIG. 10A is assembled in the manner as described above. Thereafter, the tilt frame 612 is housed in the recess portion 621a of the pan frame 621. In performing the above operation, the pan frame 621 is positioned so that the two bearings 612d and holes 621d in the pan frame 621 are vertically aligned. Then, in this state, the support shaft 622 is passed through two bearings 612e, and the hole 621d in the pan frame 621; and then, is fixed to the pan frame 621 by an adhesive. With the above operation, the structure body shown in FIG. 10B is formed. In this state, the pan frame 621 is pivotally movable around the support shaft 622, and is slightly movable up and down along the support shaft 622.

After the pan unit 620 is mounted as described above, the mirror 650 is placed in the step portions 621e of the pan frame 621, and fixed thereat. Thereafter, the bearings 616a and 616b mounted on both ends of the support shaft 611 of the tilt unit 610 are placed in the recess portions 641b of the yoke 641 shown in FIG. 9. Then, in this state, the shaft fixing member 642 is mounted on the yoke 641 so that the bearings 616a and 616b do not fall from the recess portions 641b. Specifically, the shaft fixing member 642 is mounted on the yoke 641 in such a manner that the receiving portion 642c holds the bearing 616a from below, and that the receiving portion 642d holds the bearing 616b from the front side of the mirror actuator 600. In this state, two screws 643 are fastened into the screw holes 641c of the yoke 641 through the two holes 642e of the shaft fixing member 642. Thereby, a structure member shown in FIG. 10B is mounted on the yoke unit 640.

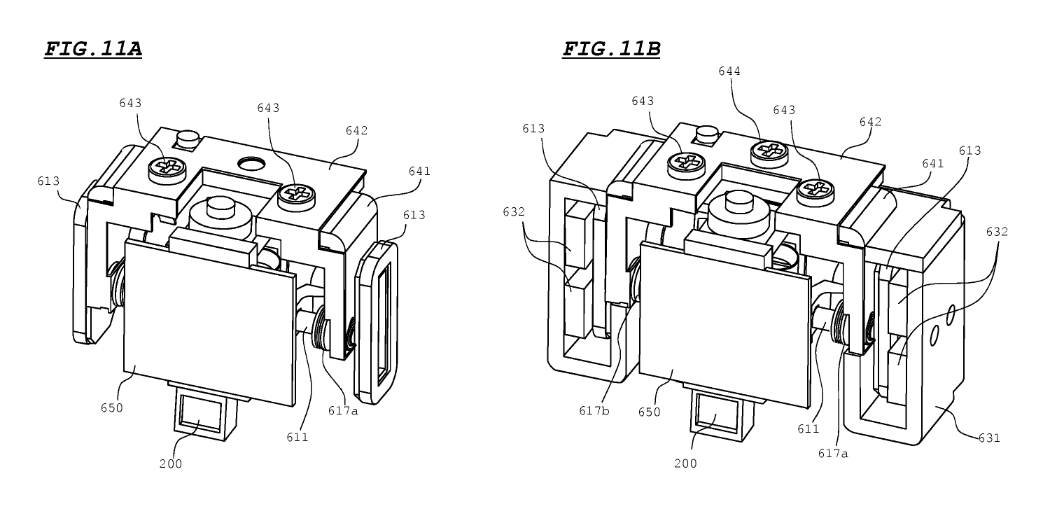

In this way, a structure member shown in FIG. 11A is assembled. In this state, the tilt frame 612 is pivotally movable about the support shaft 611 with the pan frame 621, and is slightly movable transversely along the support shaft 611.

The assembled structure member shown in FIG. 11A is mounted on the magnet unit 630 in such a manner that the two wall portions 641a of the yoke 641 are respectively inserted in the cutaways 631c of the frame 631 of the magnet unit 630. Then, in this state, a screw 644 is fastened into the screw hole 641d of the yoke 641 and in the screw hole 631d of the magnet unit 630 through the hole 642f of the shaft fixing member 642. With this operation, the structure member shown in FIG. 11A is fixedly mounted to the magnet unit 630. Thus, assembling the mirror actuator 600 is completed, as shown in FIG. 11B.

In the assembled state shown in FIG. 11B, when the pan frame 621 is pivotally moved about the support shaft 622, the mirror 650 is also pivotally moved with the pan frame 621. Further, when the tilt frame 612 is pivotally moved about the support shaft 611, the pan unit 620 is pivotally moved with the tilt frame 612, and the mirror 650 is pivotally moved with the pan unit 620. In this way, the mirror 650 is supported on the support shafts 611 and 622 orthogonal to each other to be pivotally movable, and is pivotally moved about the support shafts 611 and 612 by energization of the tilt coils 613 and the pan coil 623. At the same time, the transparent member 660 mounted on the pan unit 620 is pivotally moved in accordance with the pivotal rotation of the mirror 650.

The balancer 622d is adapted to adjust pivotal movement of the structure member shown in FIG. 10B about the support shaft 611 in a well-balanced manner. The balancing of pivotal movement is adjusted by the weight of the balancer 622d. Alternatively, as far as the balancer 622d is vertically displaceable, it is possible to adjust the balancing of pivotal movement by finely adjusting the position of the balancer 622d in a vertical direction.

In the assembled state shown in FIG. 11B, the dispositions and the polarities of the eight tilt magnets 632 are adjusted so that a force for pivotally moving the tilt frame 612 about the support shaft 611 is generated by application of a current to the tilt coils 613. Accordingly, when a current is applied to the tilt coils 613, the tilt frame 612 is pivotally moved about the support shaft 611 by an electromagnetic force generated in the tilt coils 613, and the mirror 650 and the transparent member 660 are pivotally moved with the tilt frame 612.

Further, in the assembled state shown in FIG. 11B, the dispositions and the polarities of the two pan magnets 633 are adjusted so that a force for pivotally moving the pan frame 621 about the support shaft 622 is generated by application of a current to the pan coil 623. Accordingly, when a current is applied to the pan coil 623, the pan frame 621 is pivotally moved about the support shaft 622 by an electromagnetic force generated in the pan coil 623, and the mirror 650 and the transparent member 660 are pivotally moved with the pan frame 621.

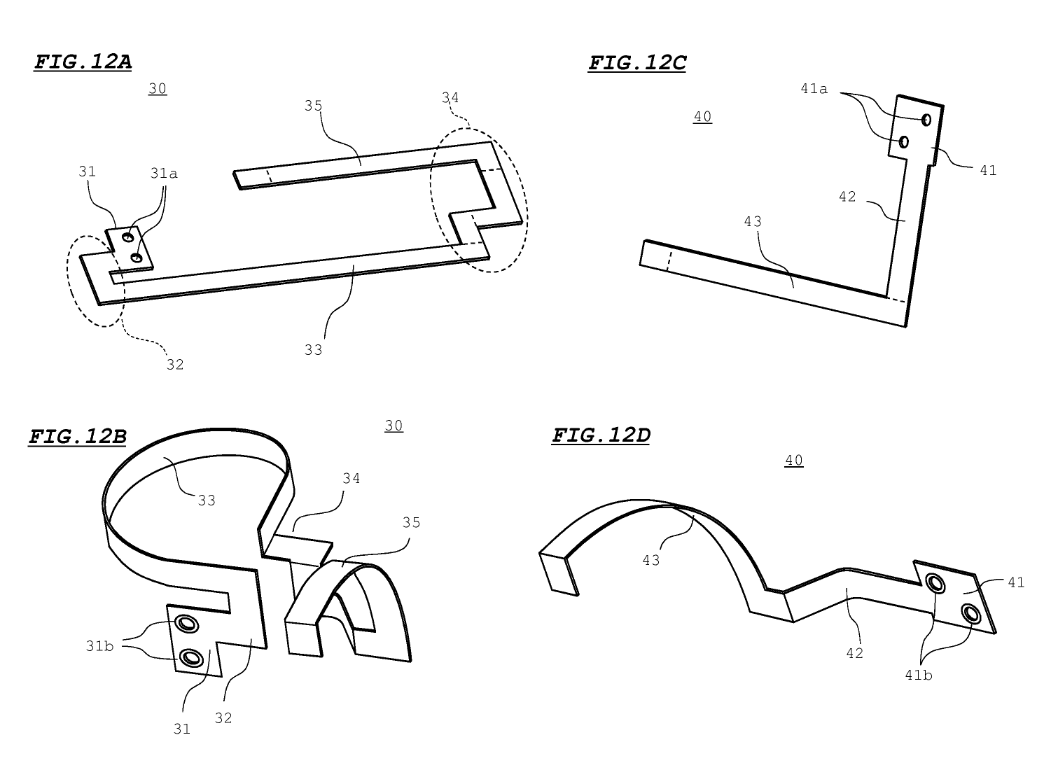

In this embodiment, a first FPC 30 and a second FPC 40 for supplying a current to the pan coil 623 and the tilt coils 613 may be mounted on the mirror actuator 600, as shown in FIGS. 12A through 12D. The first FPC 30 and the second FPC 40 are mounted at the time of assembling the mirror actuator 600 as described above. Specifically, the first FPC 30 is mounted on the coil mounting portion 621h before the pan coil 623 is mounted on the coil mounting portion 621h. Further, the second FPC 40 is mounted on the tilt frame 612 before the pan unit 620 is mounted on the tilt unit 610.

FIGS. 12A through 12D are diagrams showing arrangements of the first FPC 30 and the second FPC 40. FIGS. 12A and 12C are respectively perspective views of the first FPC 30 and the second FPC 40, and FIGS. 12B and 12D are respectively perspective views showing states that the first FPC 30 and the second FPC 40 are mounted on the mirror actuator 600.

Referring to FIG. 12A, the first FPC 30 is provided with a mounting portion 31, bent portions 32 and 34, and straight portions 33 and 35. The mounting portion 31 is formed with two holes 31a, and an electrode 31b is exposed from the upper surface of the mounting portion 31 around each of the holes 31a.

The first FPC 30 has a thin plate-like shape, and is flexible with elasticity in the thickness direction of the first FPC 30. A connector (not shown) is disposed at one end of the straight portion 35. Two signal lines extend from the connector to the electrodes 31b of the mounting portion 31 along the upper surface of the first FPC 30. The upper surface and the lower surface of the first FPC 30 are covered by an insulating member. The two holes 31a and portions corresponding to the electrodes 31b around the two holes 31a are not covered by an insulating member. The first FPC 30 is bent at the dotted-line position shown in FIG. 12A, and is mounted on the mirror actuator 600 in a state as shown in FIG. 12B.

Referring to FIG. 12C, the second FPC 40 is provided with a mounting portion 41, and straight portions 42 and 43. The mounting portion 41 is formed with two holes 41a, and an electrode 41b is exposed from the upper surface of the mounting portion 41 around each of the holes 41a.

The second FPC 40 has a thin plate-like shape, and is flexible with elasticity in the thickness direction of the second FPC 40. A connector (not shown) is disposed at one end of the straight portion 43. Two signal lines extend from the connector to the electrodes 41b of the mounting portion 41 along the upper surface of the second FPC 40. The upper surface and the lower surface of the second FPC 40 are covered by an insulating member. The two holes 41a and portions corresponding to the electrodes 41b around the two holes 41a are not covered by an insulating member. The second FPC 40 is bent at the dotted-line position shown in FIG. 12C, and is mounted on the mirror actuator 600 in a state as shown in FIG. 12D.

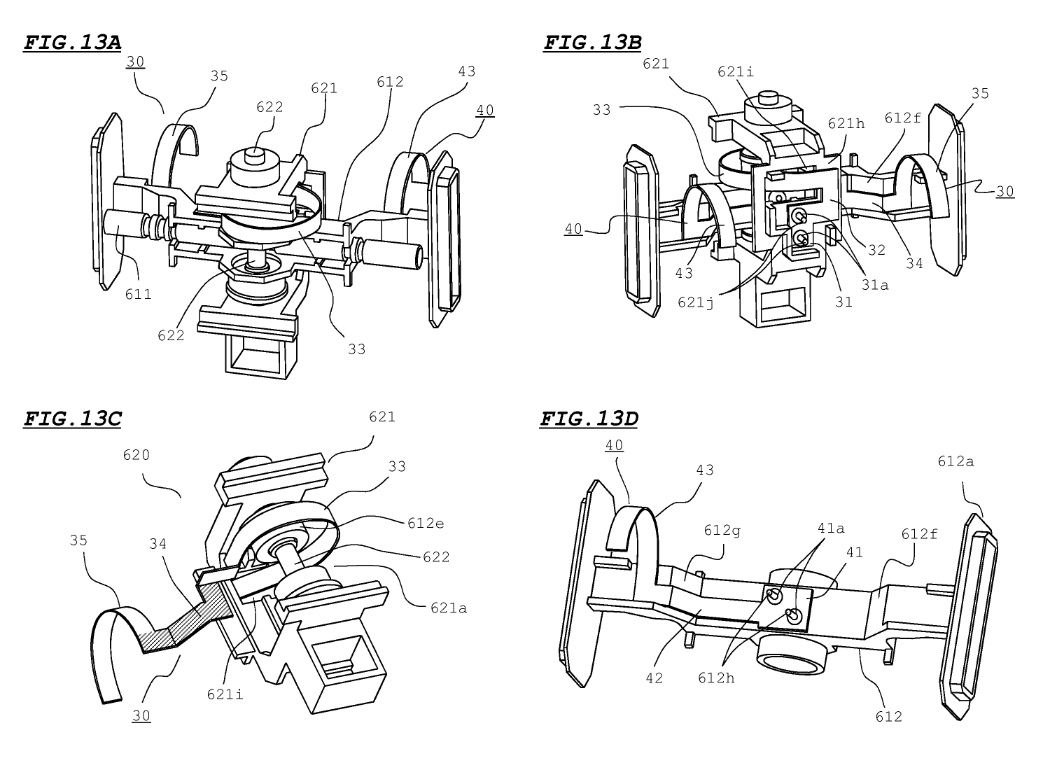

FIGS. 13A through 13D are diagrams for describing a method for mounting the first FPC 30 and the second FPC 40. FIGS. 13A and 13B are respectively perspective views showing states that the first FPC 30 and the second FPC 40 are mounted on the structure body shown in FIG. 10B when viewed from the front surface side and the back surface side of the structure body. FIG. 13C is a perspective view showing a state that the first FPC 30 is mounted on the pan frame 621 when viewed from the front surface side of the pan frame 621, and FIG. 13D is a perspective view showing a state that the second FPC 40 is mounted on the tilt frame 612 when viewed from the back surface side of the pan frame 621. In FIGS. 13A through 13D, illustration of the tilt coils 613 and the pan coil 623 is omitted to simplify the description.

As shown in FIG. 13C, the first FPC 30 is mounted on the pan frame 621 in a state that the first FPC 30 is drawn from the back surface side of the pan frame 621 toward the front surface side thereof while passing through the opening 621i. As shown in FIG. 13B, two pins 621j are formed on the coil mounting portion 621h on the back surface of the pan frame 621. The pins 621j are inserted into the holes 31a formed in the mounting portion 31 of the first FPC 30, and the mounting portion 31 and the bent portion 32 of the first FPC 30 are adhesively fixed to the coil mounting portion 621h. Then, the straight portions 33 and 35, and the bent portion 34 of the first FPC 30 are drawn toward the front surface side through the opening 621i in the coil mounting portion 621h.

As shown in FIG. 13D, two pins 612h are formed on the back surface of the tilt frame 612. The pins 612h are inserted into the holes 41a formed in the mounting portion 41 of the second FPC 40, and the mounting portion 41 and the straight portion 42 of the second FPC 40 are adhesively fixed to a back surface 612g of the tilt frame 612 along the back surface 612g.

The pan unit 620 mounted with the first FPC 30 as shown in FIG. 13C is mounted on the tilt frame 612 mounted with the second FPC 40 as shown in FIG. 13D in the manner as described above. In performing the above operation, the bent portion 34 indicated by the hatched portion in FIG. 13C is adhesively fixed to a back surface 612f of the tilt frame 612 along the back surface 612f. Thus, the structure body shown in FIGS. 13A and 13B is assembled.

Thereafter, as shown in FIG. 11A, the yoke unit 640 is mounted on the structure body shown in FIGS. 13A and 13B. Then, as shown in FIG. 11B, the structure body is mounted on the magnet unit 630. In performing the above operation, the straight portion 35 of the first FPC 30 and the straight portion 43 of the second FPC 40 are drawn toward the back surface side of the magnet unit 630 through the slits (not shown) formed in the upper portion on the back surface of the frame 631 of the magnet unit 630. The slits have such a size as to allow smooth movement of the straight portion 35 of the first FPC 30 and the straight portion 43 of the second FPC 40 when the tilt frame 612 is pivotally moved. Thus, assembling of the mirror actuator 600 is completed.

In the state shown in FIG. 13D, both ends of the tilt coils 613 mounted on the left and right coil mounting portions 612a are wound around the corresponding pins 612h. Specifically, one end of each coil is wound around one of the two pins 612h, and the other end of each coil is wound around the other one of the two pins 612h. In this state, the ends of the tilt coils 613 and the electrodes 41b around the holes 41a are connected by soldering.

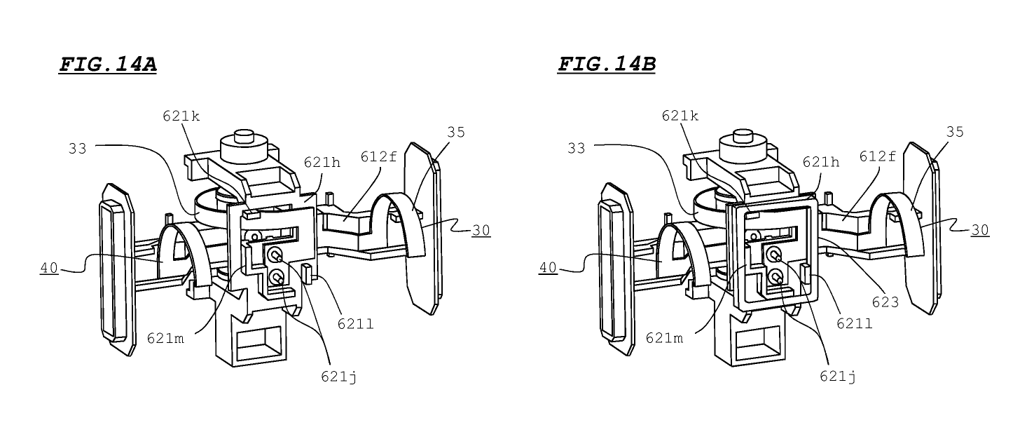

Further, in the state shown in FIG. 13B, the pan coil 623 is mounted on the coil mounting portion 621h from above the mounting portion 31 of the first FPC 30. FIGS. 14A and 14B are diagrams for describing a method for mounting the pan coil 623. As shown in FIG. 14A, projections 621k , 621l, and 621m for positioning the pan coil 623 are formed on the coil mounting portion 621h. The projections 621k , 621l, and 621m are mounted in an opening formed in the inner periphery of the pan coil 623, and then, the pan coil 623 is adhesively fixed to the coil mounting portion 621h, as shown in FIG. 14B. In this state, both ends of the pan coil 623 are wound around the corresponding pins 612j.

In this embodiment, as well as the first embodiment, the bent portion 34 of the first FPC 30 is fixedly attached to the tilt frame 612 in a state that the straight portion 33 of the first FPC 30 is wound around the support shaft 622. Accordingly, the pan frame 621 receives a force to pivotally move around the support shaft 622 by a spring property (a resilient recovering force) of the straight portion 33. Thus, similarly to the first embodiment, controlling the mirror actuator 600 so that the direction of the force coincides with the direction of a force for assisting a returning operation of a mirror 650 to the scan start position enables to quickly return the pan frame 621 and the mirror 650 to the scan start position, without the need of exceedingly increasing a current to be applied to the pan coil 623 at the time of performing a returning operation.

Further, in this embodiment, as well as the first embodiment, as shown in FIG. 13B, since both of the straight portion 35 of the first FPC 30 and the straight portion 43 of the second FPC 40 are bent downwardly, the tilt frame 612 is urged to be tilted downwardly by a spring property (a resilient recovering force) of the straight portions 35 and 43. In view of this, in this embodiment, as well as the first embodiment, it is preferable to set the scan start position around the support shaft 611 to such a position that the tilt frame 612 is tilted downwardly. This enables to quickly return the tilt frame 612 and the mirror 650 to the scan start position around the support shaft 611 by an assisting operation using a spring property (a resilient recovering force) of the straight portions 35 and 43.

The embodiments of the invention have been described as above. The invention is not limited to the foregoing embodiments, and the embodiments of the invention may be modified in various ways other than the above.

For instance, the arrangement examples of a mirror actuator for pivotally moving a mirror about two axes are described in the foregoing two embodiments. The invention may be applicable to a mirror actuator having an arrangement other than the above.

Further, in the embodiments, FPC is described as an example of a wiring member. The wiring member is not limited to FPC, and other wiring member having elasticity in a flexing direction, such as FFC (flexible flat cable), may be used. Further alternatively, scanning laser light may be scanned by displacing an optical element (e.g. a lens) other than a mirror. Further alternatively, the mirror actuator 100 may have an arrangement other than the above, as far as the mirror actuator 100 has at least one pivot axis.

The embodiment of the invention may be changed or modified in various ways as necessary, as far as such changes and modifications do not depart from the scope of the present invention hereinafter defined.

What is claimed is:

1. A beam irradiation device comprising:
a laser light source which emits laser light;
an actuator which causes the laser light to scan a targeted area; and
a wiring portion which supplies a drive signal to the actuator, wherein
the actuator includes
a first movable portion which is pivotally movable around a first axis,
an optical element which is disposed on the first movable portion, and on which the laser light is entered, and
a first coil which is disposed on the first movable portion, and
the wiring portion includes
a wiring member which is electrically connected to the first coil, has a spring property in a flexing direction, and is arranged in such a condition as to urge the first movable portion toward a first scan start position around the first axis, using the spring property.

2. The beam irradiation device according to claim 1, wherein
the wiring member includes a flexible printed circuit board.

3. The beam irradiation device according to claim 1, wherein
the actuator includes
a second movable portion which supports the first movable portion to be pivotally movable around the first axis, and which is pivotally movable around a second axis perpendicular to the first axis, and
a second coil which is disposed on the second movable portion, wherein
a part of the wiring member is fixed to the second movable portion so that the first movable portion receives an urging force by the spring property from the second movable portion toward the first scan start position.

4. The beam irradiation device according to claim 3, wherein
the wiring member is electrically connected to the second coil, and is arranged in such a condition as to urge the second movable portion toward a second scan start position around the second axis, using the spring property.

5. The beam irradiation device according to claim 3, wherein
the wiring member is disposed at each of an upper portion and a lower portion of the movable portion, and ends of the first coil are connected to the two respective wiring members.

6. The beam irradiation device according to claim 3, wherein
the wiring portion includes another wiring member which supplies a signal to the second coil, and
the another wiring member is electrically connected to the second coil, has a spring property in a flexing direction, and is arranged in such a condition as to urge the second movable portion toward a second scan start position around the second axis, using the spring property.
